(19) United States
(12) Patent Application Publication
(10) Pub. No.: US 2014/0006226 A1
(43) Pub. Date: Jan. 2, 2014

(54) MONITORING APPARATUS AND MONITORING METHOD

(71) Applicant: FUJITSU LIMITED, Kawasaki-shi (JP)

(72) Inventor: Kotaro KATSUBE, Yokohama (JP)

(73) Assignee: FUJITSU LIMITED, Kawasaki-shi (JP)

(21) Appl. No.: 13/872,616

(22) Filed: Apr. 29, 2013

(30) Foreign Application Priority Data
Jun. 29, 2012 (JP) 2012-147179

(51) Int. Cl. G06Q 10/08

(52) U.S. Cl. CPC G06Q 10/087
USPC 705/28

(57) ABSTRACT

A method that is executed by a apparatus that monitors a numerical value in business data to be processed by an information processing system that executes business processing, the method includes, collecting a plurality of the numerical values that are a monitoring target based on collection target information of a threshold value decision rule which is predetermined, in response to a setting instruction of the threshold value; calculating an average value of the numerical values for each predetermined time interval; determining whether the average value is stabilized based on variation of a plurality of the average values; storing to the threshold value that is determined based on the stabilized average value in the storage unit when it is determined that the average value is stabilized; and determining whether an alert is notified, based on a comparison result of a numerical value in newly collected business data and the determined threshold value.

### CROSS-REFERENCE TO RELATED APPLICATION

This application is based upon and claims the benefit of priority of the prior Japanese Patent Application No. 2012-147179, filed on Jun. 29, 2012, the entire contents of which are incorporated herein by reference.

### FIELD

The embodiments discussed herein are related to a monitoring apparatus, a computer-readable medium storing a program, and a monitoring method.

### BACKGROUND

A device has been proposed that collects various pieces of data and work logs to be processed by a business system in real-time, and displays (also referred to as “visualizes”) the contents of the collected various pieces of data and work logs. By this device, an administrator of this business system can perform rapid determination depending on the actual work status and accurate response for caused troubles.

As an example of such a device, a monitoring apparatus has been proposed that monitors various pieces of data and work logs to be processed by a business system. Hereinafter, the above described various pieces of data and work logs are referred to as “business data” as appropriate. The monitoring apparatus compares a numerical value that is a monitoring target in the business data with a threshold value of the numerical value and notifies an alert based on the comparison result.

When the business system is an inventory management system, business data to be processed by the inventory management system includes, for example, a product name and a stock quantity of the product on a certain date at a certain shop. Here, a numerical value that is a monitoring target is the stock quantity. The monitoring apparatus monitors the stock quantity of the product and notifies to a user of the monitoring apparatus that there is not enough stock quantity when the stock quantity of the product is less than a threshold value for a safe stock. In addition, the monitoring apparatus notifies to the user of the monitoring apparatus that the stock quantity of the product is excessive when the stock quantity of the product exceeds a threshold value for an excess stock. The user adjusts the stock quantity by determining timing of product order in response to the notification. The notification is also referred to as alert notification.

In addition, in another technical field, for example, a technology has been proposed that uses an average value of data values in order to determine a threshold value of the data value that is processed in a device.

### RELATED ART

Japanese Patent Application Laid-Open No. 9-123790,
Japanese Patent Application Laid-Open No. 2001-000004,
Japanese Patent Application Laid-Open No. 2006-109263

In such a monitoring apparatus, in order to perform the above-described alert notification appropriately, it is desirable that an optimal threshold value is determined for a numerical value that is a monitoring target in business data. However, for example, numerical values that are monitoring targets in business data to be processed by the business system depend on the business contents and vary widely. Therefore, it is difficult to determine an optimal threshold value for the numerical value that is a monitoring target in the business data.

### SUMMARY

According to an aspect of the embodiments, a monitoring apparatus that monitors a numerical value in business data to be processed by an information processing system that executes business processing, the monitoring apparatus includes a storage unit that stores a threshold value of the numerical value that is a monitoring target in the business data; and a control unit that collects the business data from the information processing system and determines whether an alert is notified based on a comparison result of the numerical value in the business data and the threshold value, wherein the control unit collects a plurality of the numerical values that are the monitoring target based on collection target information of the threshold value decision rule which is predetermined, in response to a setting instruction of the threshold value, calculates an average value of the numerical values for each predetermined time interval, determines whether the average value is stabilized based on variation of a plurality of the average values, and stores the threshold value that is determined based on the stabilized average value in the storage unit when it is determined that the average value is stabilized.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a hardware block diagram illustrating an overall system according to an embodiment;

FIG. 2 is a diagram schematically illustrating an example of a threshold value decision rule in FIG. 1;

FIG. 3 is a diagram illustrating an example of an input table in FIG. 1;

FIG. 4 is a diagram illustrating an example of an aggregation table in FIG. 1;

FIG. 5 is an example of a block diagram of a software module that is executed by a monitoring apparatus in FIG. 1;

FIG. 6 is a flowchart illustrating a flow of processing of the monitoring apparatus in FIG. 5;

FIG. 7 is a graph schematically illustrating a flow of stabilization determination processing of an average value in FIG. 6;

FIG. 8 is a flowchart illustrating the flow of the stabilization determination processing of an average value in FIG. 6;

FIG. 9 is a diagram schematically illustrating another example of the threshold value decision rule in FIG. 1;

FIG. 10 is a diagram illustrating another example of the input table in FIG. 1;

FIG. 11 is a diagram illustrating another example of the aggregation table in FIG. 1;

FIG. 12 is a graph schematically illustrating a flow of re-decision processing of an alert determination threshold value; and

FIG. 13 is a flowchart illustrating the flow of the re-decision processing of the alert determination threshold value.

### DESCRIPTION OF EMBODIMENTS

### First Embodiment

### System

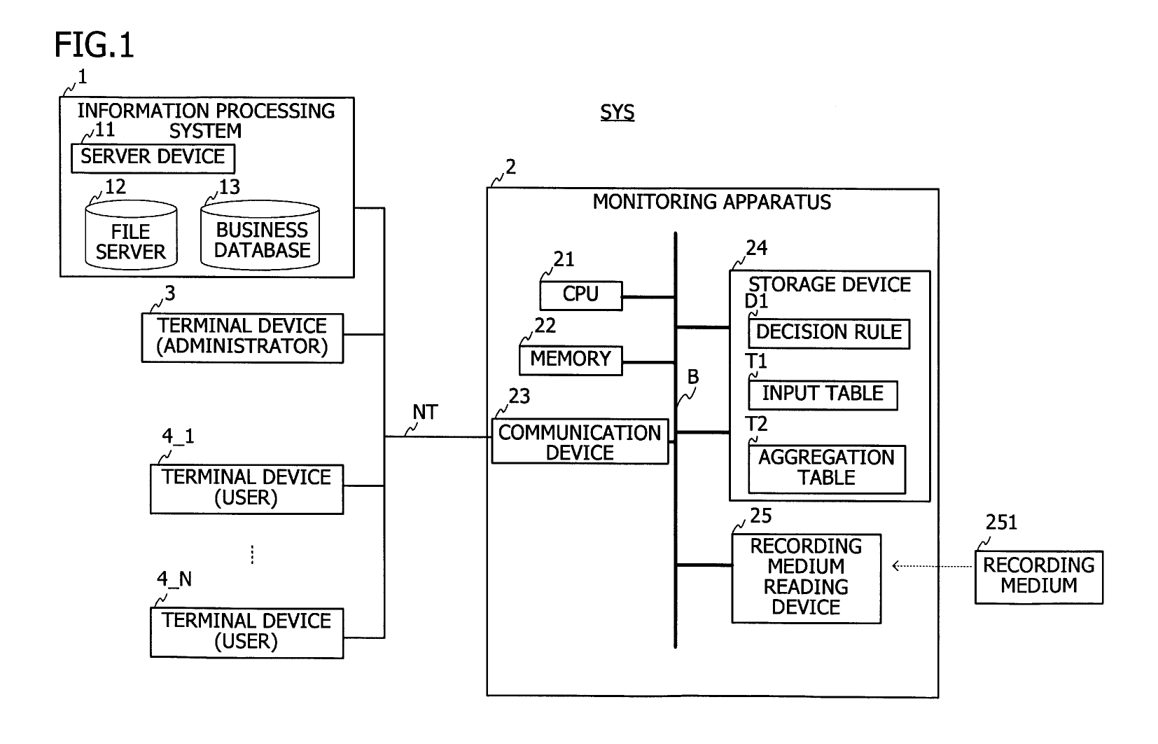

FIG. 1 is a hardware block diagram illustrating an overall system SYS according to a first embodiment. In the following description, the same reference numbers are assigned to the same elements, and the description is omitted as appropriate.

The overall system SYS includes an information processing system 1, a monitoring apparatus 2, a terminal device (administrator) 3, and a first terminal device (user) 4_1 to an N-th (“N” is an integer of two or more) terminal device 4_N that are connected to a network NT. The network NT is, for example, a local area network (LAN).

The information processing system 1 is a business system that executes (also referred to as “manages”) business processing, such as an inventory management system that executes inventory management processing and a courier cargo management system that executes courier cargo management processing. The information processing system 1 includes a server device 11, a file server 12, and a business database (DB) 13 that are connected to each other through an internal network (not illustrated).

The server device 11 collects business data to be processed by the information processing system 1 and transmits the collected business data to the file server 12 and the business DB 13.

The file server 12 and the business DB 13 receive the business data that is transmitted from the server device 11 and stores the business data. In addition, the file server 12 and the business DB 13 transmit the stored business data to the monitoring apparatus 2 in response to a business data transmission request from the monitoring apparatus 2.

When the information processing system 1 is, for example, the inventory management system, the business data includes a product name at a certain shop and a stock quantity of the product at the shop on a certain date. When the information processing system 1 is the inventory management system, the server device 11 collects business data using, for example, a point of sale (POS) system. It is assumed that the business data includes a stock quantity of a certain product at one shop. In this case, the server device 11 collects, for example, business data including data of a stock quantity “275” having a product name “AAA” on a date “5/3”, and stores the data in the file server 12. In addition, the server device 11 stores business data including data of a stock quantity “880” having a product name “BBB” on the date “5/3”, in the file server 12. The stock quantity is an example of a numerical value that is a monitoring target in the business data. In the first embodiment, as the information processing system 1, the inventory management system is illustrated and described.

The monitoring apparatus 2 is a device that monitors an implementation status and performance of the business contents that is performed by hand. The monitoring is also referred to, for example, as business activity monitoring (BAM). The monitoring apparatus 2 collects business data from the information processing system 1 and notifies various pieces of information such as monitoring contents, to the terminal device 4_1 of the user, based on the collected business data. The monitoring apparatus 2 aggregates, for example, various numerical values of the business data, graphs the various numerical values in chronological order, and notifies change contents in the time series of the business data, to the terminal device 4_1 of the user of the monitoring apparatus 2. The user is also the administrator of the business system. In addition, the monitoring apparatus 2 compares a numerical value that is a monitoring target in the business data with a threshold value of the numerical value, and notifies an alert based on the comparison result. The monitoring apparatus 2 is an example of a device that monitors a numerical value in the business data to be processed by the information processing system 1 that executes the business processing.

The monitoring apparatus 2 includes, for example, a central processing unit (CPU) 21, a memory 22, a communication device 23, a storage device 24, and a recording medium reading device 25 that are connected to each other through a bus B.

The CPU 21 is a computer (control unit) that controls the whole monitoring apparatus 2. The memory 22 temporarily stores data that is processed in various pieces of information processing that is executed by the CPU 21 and various programs.

The communication device 23 is, for example, a network interface card (NIC), is connected to the network NT, and performs communication with various devices that are connected to the network NT.

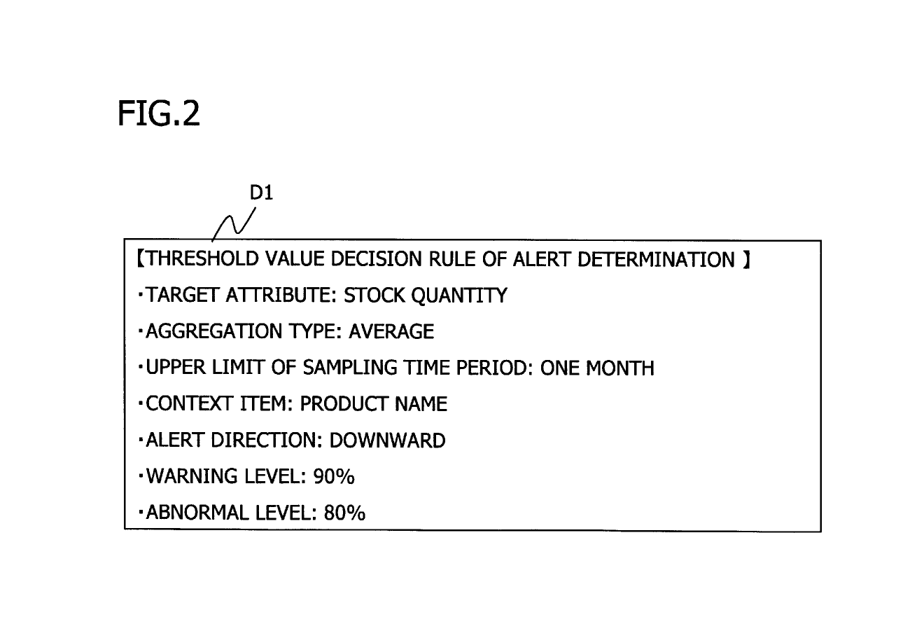

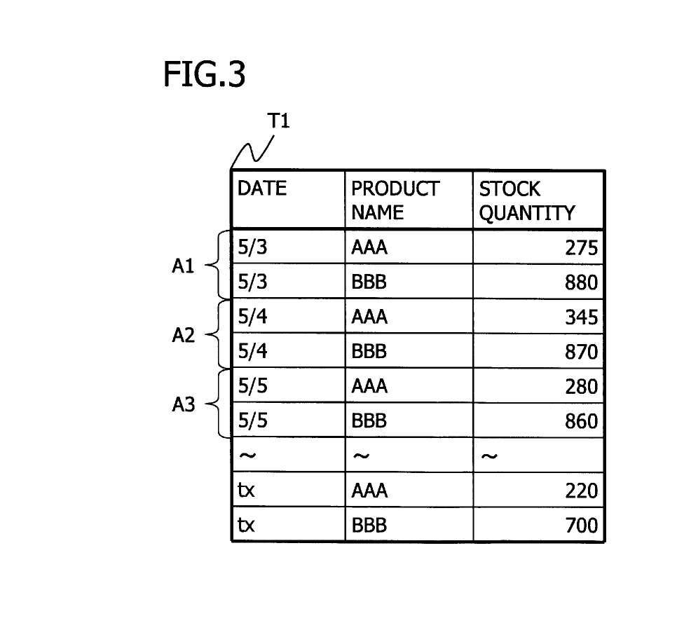

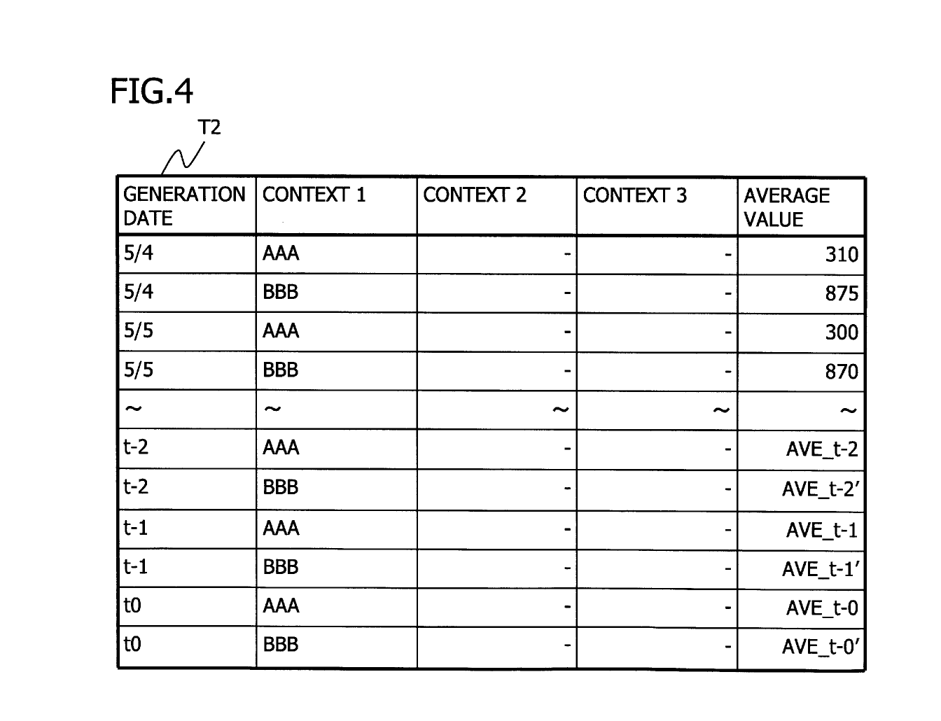

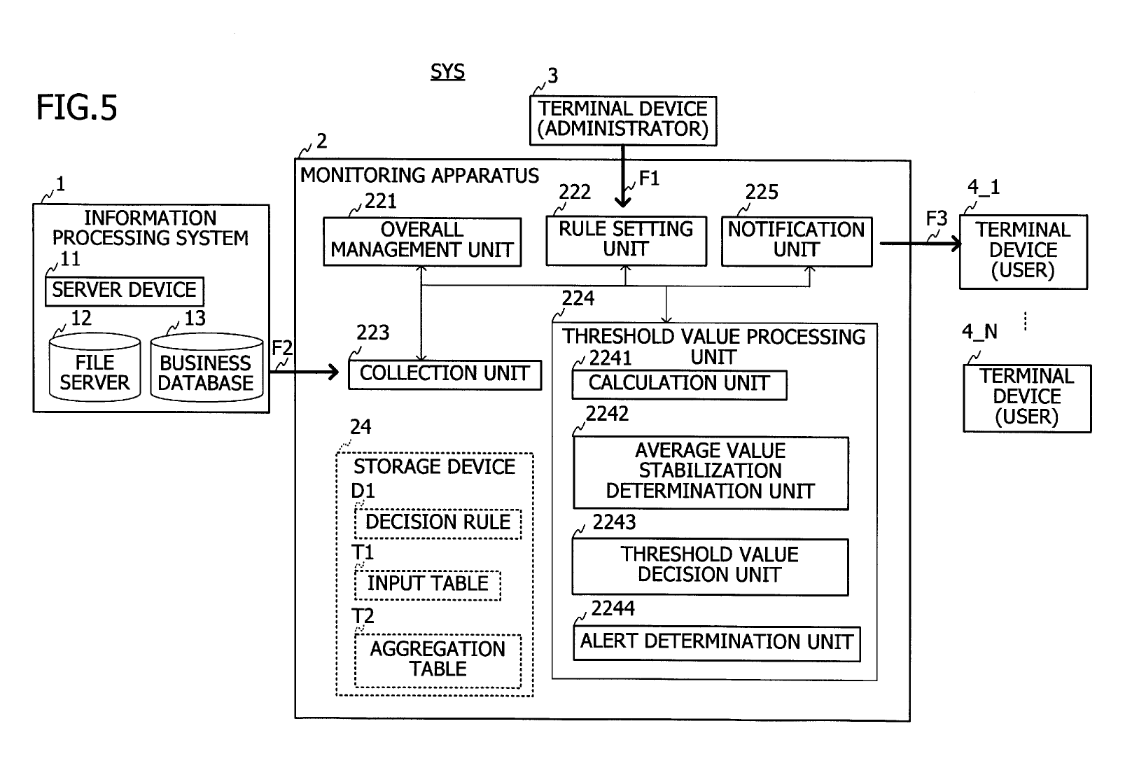

The storage device 24 is, for example, a magnetic storage device such as a hard disk drive (HDD) and a non-volatile memory. The storage device 24 stores a threshold value decision rule D1 that is described in FIG. 2, an input table T1 that is described in FIG. 3, an aggregation table T2 that is described in FIG. 4, a program that is described in FIG. 5, and other pieces of data. As described in FIG. 5, the storage device 24 is an example of a storage unit that stores a threshold value of a numerical value that is a monitoring target in the monitoring apparatus 2.

The recording medium reading device 25 is a device that reads data that is recorded in a recording medium 251. The recording medium 251 is, for example, a portable recording medium such as a compact disc read only memory (CD-ROM), a digital versatile disc (DVD), and a universal serial bus (USB) memory. The program that is described in FIG. 5 may be recorded in the recording medium 251.

The terminal device 3 is an administrator terminal device that manages the monitoring apparatus 2 and creates the threshold value decision rule D1 that is described in FIG. 2.

Each of the first terminal device 4_1 to the N-th terminal device 4_N is a user terminal device of the monitoring apparatus 2, is connected, for example, to the monitoring apparatus 2 through a web browser, receives various pieces of information that are notified by the monitoring apparatus 2, and displays the information. Each of the first terminal device 4_1 to the N-th terminal device 4_N is also referred to as a dashboard.

FIG. 2 is a diagram schematically illustrating an example of the threshold value decision rule D1 in FIG. 1. The threshold value decision rule D1 is rule information that is referred to when the monitoring apparatus 2 in FIG. 1 decides (also referred to as “generates”) a threshold value that is desired when determining whether an alert is notified. The rule information is also referred to as a threshold value decision rule for alert determination. Hereinafter, the above-described threshold value is referred to as an alert determination threshold value as appropriate.

The threshold value decision rule includes a target attribute that indicates attribute information of a numerical value that is a monitoring target in business data, an aggregation type of the numerical value, an upper limit of a sampling time period that is from a start of sampling of the business data to decision of an alert determination threshold value. In addition, the threshold value decision rule includes a context item that is identification information (also referred to as context) uniquely identifying the above-described attribute information (target attribute), and an alert direction that is desired when the determination processing is executed based on the alert determination threshold value. The context is also classification information that is used to store a threshold value of the numerical value that is a monitoring target for each type of the numerical value. The alert direction is an example of determination information to determine whether to notify an alert.

In addition, the threshold value decision rule includes a warning level and an abnormal level that are used to determine an alert determination threshold value. The warning level and abnormal level are examples of threshold value decision information that is used to determine a threshold value.

The administrator of the monitoring apparatus 2 in FIG. 1 inputs a threshold value decision rule by operating the terminal device 3 to transmit the threshold value decision rule to the monitoring apparatus 2. In the example of the threshold value decision rule D1 in FIG. 2, the administrator inputs “stock quantity” as the target attribute, “average” as the aggregation type, and “one month” as the upper limit of the sampling time period by operating the terminal device 3. In addition, the administrator inputs “product name” as the context item, “downward” as the alert direction, “90%” as the warning level, and “80%” as the abnormal level by operating the terminal device 3. The terminal device 3 transmits a threshold value decision rule including the input contents to the monitoring apparatus 2. The administrator inputs “downward” as the alert direction when the administrator desires to monitor a safe stock quantity of the product.

FIG. 3 is a diagram illustrating an example of the input table T1 in FIG. 1. The input table T1 in FIG. 3 schematically illustrates a state in which the monitoring apparatus 2 in FIG. 1 stores the business data that is newly collected from the information processing system 1 in a table format, in the storage device 24.

The input table T1 includes a date field, a product name field, and a stock quantity field, and stores, for example, a stock quantity of a certain product at a certain shop. The date field stores a date on which a stock quantity of the product is identified. The product name field stores a product name of the business data. The stock quantity field stores a stock quantity of the product name. A field in which a wavy line is illustrated in the input table T1 indicates that description of the data is omitted, and the storage device 24 stores the omitted data in practice. Hereinafter, the above-described case is applied to another table.

The input table T1 stores, for example, a stock quantity “275” having a product name “AAA” on the date “5/3” that is stored in the date field, at a certain shop. The detail description of FIG. 3 is made in FIG. 5.

FIG. 4 is a diagram illustrating an example of the aggregation table T2 in FIG. 1. The aggregation table T2 is a table that is generated by the monitoring apparatus 2 based on the threshold value decision rule D1 in FIG. 2 and the input table T1 in FIG. 3. The aggregation table T2 includes a generation date field, fields of context 1, 2, and 3, and an average value field. In the aggregation table T2, a field in which a horizontal straight line is illustrated indicates that data is not stored. Hereinafter, the above-described case is applied to another table.

The generation date field indicates a date on which a certain line (in other word, row) in the table is generated. Each of the fields of context 1, 2, and 3 stores the contents of the business data, which correspond to a context item of a threshold value decision rule. In the case of the threshold value decision rule D1 in FIG. 2, the context item is “product name”. In addition, in the case of the above-described business data, the contents that correspond to “product name” are product names “AAA” and “BBB”. The average value field stores an average value of numerical values of a target attribute for each of the context items in the collected business data. In the case of the threshold value decision rule D1, the target attribute is “stock quantity”. Therefore, the average value field stores an average value of stock quantities having the product name “AAA” and an average value of stock quantities having the product name “BBB”.

The aggregation table T2 stores, for example, an average value “310” of stock quantities having the product name “AAA” on the date “5/4” that is stored in the generation date field. The detail description of FIG. 4 is made in FIG. 5.

### Software Module Block Diagram of the Monitoring Apparatus 2

FIG. 5 is an example of a block diagram of a software module that is executed by the monitoring apparatus 2 in FIG. 1.

The monitoring apparatus 2 includes an overall management unit 221, a rule setting unit 222, a collection unit 223, a threshold value processing unit 224, and a notification unit 225, as a software module. The threshold value processing unit 224 includes a calculation unit 2241, an average value stabilization determination unit 2242, a threshold value decision unit 2243, and an alert determination unit 2244. For the description of FIG. 5, the storage device 24 is illustrated by the dotted line in the monitoring apparatus 2.

The overall management unit 221 manages various pieces of processing that are executed by the monitoring apparatus 2. The overall management unit 221 manages, for example, the rule setting unit 222, the collection unit 223, the threshold value processing unit 224, and the notification unit 225. In addition, the overall management unit 221 executes transmission and reception processing of various pieces of data to and from a device that is connected to the communication device 23 (see FIG. 1). In addition, the overall management unit 221 creates monitoring result information and notifies the information to the terminal device 4_1 of the user through the notification unit 225. The monitoring result information is, for example, information obtained after aggregating various numerical values in business data that is collected from the information processing system 1 by the collection unit 223 and graphing the values in chronological order.

The overall management unit 221, the rule setting unit 222, the collection unit 223, the threshold value processing unit 224, the calculation unit 2241, the average value stabilization determination unit 2242, the threshold value decision unit 2243, the alert determination unit 2244, the notification unit 225 are so-called programs. These programs are stored, for example, in the storage device 24. The CPU 21 in FIG. 1 reads these programs from the storage device 24 at startup and deploys these programs to the memory 22 to cause these programs to function as software modules.

These programs may be recorded in the recording medium 251 that is read by the recording medium reading device 25 illustrated in FIG. 1. In this case, the CPU 21 in FIG. 1 reads these programs from the recording medium 251 that is mounted on the recording medium reading device 25 at startup and deploys these programs to the memory 22 to cause these programs to function as software modules.

The function of the monitoring apparatus 2 in FIG. 5 is described below with reference to FIGS. 1 to 4.

The rule setting unit 222 in FIG. 5 receives a threshold value decision rule that is created using the administrator terminal device 3 by the administrator of the monitoring apparatus 2, through the communication device 23 (see a reference number F1), and stores the threshold value decision rule in the storage device 24, for example, as the threshold value decision rule D1 in FIG. 2. The storage of the threshold value decision rule D1 is setting of the threshold value decision rule D1. The threshold value decision rule D1 is, for example, in an to extensible markup language (XML) format and is also referred to as a topology.

The collection unit 223 collects the business data that is stored in the file server 12 and the business DB 13 of the information processing system 1 through the communication device 23 for each predetermined interval (see a reference number F2). The predetermined interval is referred to as a certain time interval as appropriate. The certain time interval is, for example, 24 hours, 6 hours, and 12 hours. Here, the collection unit 223 collects the business data based on collection target information of the threshold value decision rule D1 in FIG. 2. The collection target information includes the target attribute and the context item. As the business data, data other than the collection target information may be collected.

In addition, the collection unit 223 stores a numerical value that is a monitoring target for each context item in the threshold value decision rule that is set by the rule setting unit 222. This numerical value that is a monitoring target is a numerical value of the target attribute in the threshold value decision rule. In the example of FIG. 2, the context item is “product name”, and the numerical value that is a monitoring target is “stock quantity”.

The collection unit 223 stores, for example, the collected business data in the table format illustrated in the input table T1 in FIG. 3. Hereinafter, business data including a numerical value that is a monitoring target for each of the context items is referred to as unit business data as appropriate. In the example of the input table T1 in FIG. 3, business data of one line portion corresponds to the unit business data, and the unit business data includes, for example, the stock quantity “275” having the product name “AAA” on the date “5/3”.

The file server 12 stores the stock quantity “275” having the product name “AAA” on the date “5/3” and a stock quantity “880” having the product name “BBB” on the date “5/3”, as uncollected business data, in the example of FIG. 1. The collection unit 223 collects the uncollected business data from the file server 12. In addition, the collection unit 223 stores the date “5/3” in the date field of the input table T1 in FIG. 3, stores the product name “AAA” in the product name field that corresponds to the date (“5/3”), and stores the stock quantity “275” in the stock quantity field that corresponds to the product name “AAA”. In addition, the collection unit 223 stores the date “5/3” in the date field of the input table T1 in FIG. 3, stores the product name “BBB” in the product name field that corresponds to the date (“5/3”), and stores the stock quantity “880” in the stock quantity field that corresponds to the product name “BBB”.

The collection unit 223 repeats the collection processing of uncollected business data, the storage processing of the collected business data for each of the certain time intervals. As a result, the collection unit 223 sequentially stores the business data as illustrated in the input table T1 in FIG. 3.

As described above, the collection unit 223 sequentially collects a plurality of numerical values that are a monitoring target in business data from the information processing system 1, based on the collection target information of the threshold value decision rule that is predetermined, and stores the collected values in the storage device 24.

The collection unit 223 collects business data using a file protocol when the file server 12 stores the business data. When data collection processing by the file protocol is executed, the collection unit 223 is also referred to as a comma separated values (CSV) sensor. In addition, the collection unit 223 collects business data using a java database connectivity (JDBC) protocol (java is a registered trademark) when the business DB 13 stores the business data. When data collection processing by the JDBC protocol is executed, the collection unit 223 is also referred to as a DB (DB) sensor.

The threshold value processing unit 224 executes the determination processing of a threshold value. When the collection unit 223 newly collects business data, the calculation unit 2241 of the threshold value processing unit 224 executes the calculation processing for a numerical value that is a monitoring target in the collected business data, for the upper limit of the sampling time period of the threshold value decision rule D1. The calculation processing is the aggregation type in the threshold value decision rule. The calculation unit 2241 executes this calculation processing in response to a setting instruction of a threshold value. The administrator gives the setting instruction of the threshold value through the administrator terminal device 3. The numerical value that is a monitoring target is a target attribute in the threshold value decision rule.

The calculation unit 2241 executes the calculation processing for each of the context items in the threshold value decision rule. In addition, the calculation unit 2241 stores the calculation result. In the threshold value decision rule D1 of FIG. 2, the aggregation type is “average”, that is, a calculation of an average value, and the calculation processing is processing to calculate an average value.

The average value calculation is executed as follows. For example, in FIG. 3, when the number of pieces of unit business data having an identical context item is “M” (“M” is an integer of two or more), the calculation unit 2241 divides the sum of numerical values that are monitoring targets, which correspond to the identical context item, by “M”. The calculation unit 2241 sets a value that is obtained by the value of the division (“the sum of numerical values”/“M”) as an average value of the numerical values that are monitoring targets, which correspond to the context item.

That is, the calculation unit 2241 calculates an average value of numerical values that correspond to attribute information (also referred to as a target attribute) that is identified by identification information (also referred to as a context item). At this time, the calculation unit 2241 calculates an average value of the numerical values for each of certain successive time intervals.

In the threshold value decision rule D1 of FIG. 2, the context item is “product name”, and the target attribute is “stock quantity”. In this case, the calculation unit 2241 calculates an average value of stock quantities having the product name “AAA” and an average value of stock quantities having the product name “BBB”.

Here, it is assumed that the collection unit 223 stores business data of the date “5/3” that is indicated in a reference number A1 and business data of the date “5/4” that is indicated in a reference number A2, in the input table T1 of FIG. 3. In this case, the number of pieces of unit business data having an identical context item (identical product name) is two. More specifically, in unit business data having the identical product name “AAA”, there are two pieces of unit business data of the dates “5/3” and “5/4”, and in unit business data having the identical product name “BBB”, there are two pieces of unit business data of the dates “5/3” and “5/4”. Thus, the calculation unit 2241 calculates a value that is obtained by dividing (275+345) that is the sum of numerical values that are monitoring targets, which correspond to the product name “AAA” of the identical context item, by “2”, as an average value 310 ((275+345)/2).

In this case, as illustrated in the aggregation table T2 of FIG. 4, the calculation unit 2241 stores the date “5/4” in which the average value is calculated, in the date field, stores the product name “AAA” in the field of context 1, and stores the calculated average value “310” in the average value field. Similarly, the calculation unit 2241 calculates a value that is obtained by dividing (880+870) that is the sum of numerical values that are monitoring targets, which correspond to the product name “BBB” of the identical context item, by “2”, as an average value 875 ((880+870)/2). In this case, as illustrated in the aggregation table T2 of FIG. 4, the calculation unit 2241 stores the date “5/4” on which the average value is calculated, in the date field, stores the product name “BBB” in the field of context 1, and stores the calculated average value “875” in the average value field.

The calculation unit 2241 executes the calculation processing and the storage processing at a timing at which the collection unit 223 collects uncollected business data. The calculation unit 2241 may execute the calculation processing and the storage processing at a certain timing, for example, 6 hours interval, 12 hours interval, in addition to the timing.

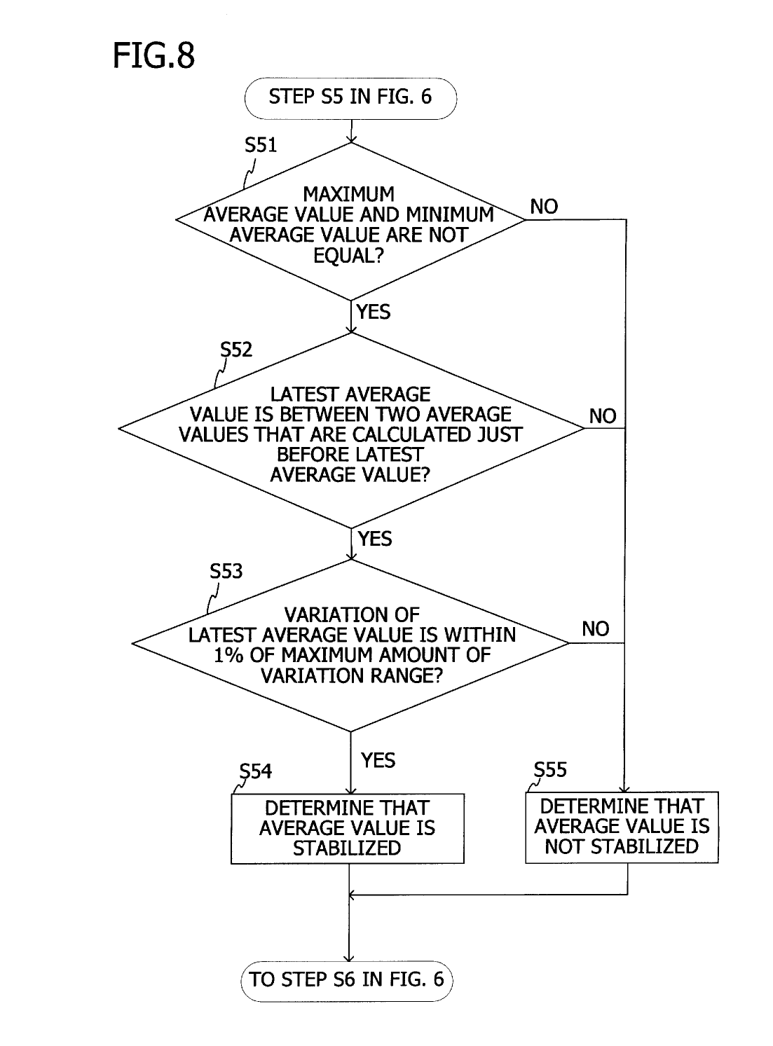

The average value stabilization determination unit 2242 calculates variation in a plurality of average values that are calculated by the calculation unit 2241, and determines whether the average value is stabilized based on the variation. The detail of the determination processing is described in FIG. 8.

When the average value stabilization determination unit 2242 determines that an average value is stabilized, the threshold value decision unit 2243 determines an alert determination threshold value for each of the context items, based on the latest average value that is calculated by the calculation unit 2241, that is, the stabilized average value, and stores the alert determination threshold value in the storage device 24. The stabilized average value is a base numerical value that is used to determine whether the monitoring apparatus 2 performs alert notification when a numerical value that is a monitoring target is greatly different from the stabilized average value. Hereinafter, the stabilized average value is referred to as a reference value as appropriate. In the first embodiment, the reference value corresponds to a key performance evaluation indicator, that is, the average value stabilization determination unit 2242 determines the above-described reference value.

As the alert determination threshold value, there are threshold values of two stages of a warning level threshold value and an abnormal notification threshold value. The meaning of the two types of threshold values is described later with reference to the alert determination unit 2244.

The threshold value decision unit 2243 determines an alert determination threshold value based on threshold value decision information of the threshold value decision rule. For example, the threshold value decision unit 2243 decides a warning level threshold value based on the reference value and a numerical value of a warning level in the threshold value decision rule, and decides an abnormal notification threshold value based on the reference value and a numerical value of an abnormal level in the threshold value decision rule.

Here, it is assumed that a reference value (stock quantity) of the product name “AAA” that is a context item, is “300”, and a reference value of the product name “BBB” that is a context item, is “800”. In addition, in the threshold value decision rule D1 of FIG. 2, a numerical value of the warning level is 0.9 (90%), and a numerical value of the abnormal level is 0.8 (80%).

In this case, the threshold value decision unit 2243 multiplies the reference value “300” of the product name “AAA” by the numerical value (0.9) of the warning level, and determines a warning level threshold value of the product name “AAA” as “270”. In addition, the threshold value decision unit 2243 multiplies the reference value “300” of the product name “AAA” by the numerical value (0.8) of the abnormal level, and determines an abnormal level threshold value of the product name “AAA” as “240”. Similarly, the threshold value decision unit 2243 determines a warning level threshold value of the product name “BBB” as “720” and determines an abnormal level threshold value of the product name “BBB” as “640”.

After the threshold value decision unit 2243 determines the alert determination threshold values, the alert determination unit 2244 compares a numerical value that is a monitoring target in the business data and a threshold value of the numerical value, and determines whether to notify an alert. That is, the alert determination unit 2244 executes the monitoring processing of the business data based on the alert determination threshold values that are determined by the threshold value decision unit 2243.

When the alert determination unit 2244 determines to perform the alert determination, the notification unit 225 performs the alert notification (see a reference number F3). The notification unit 225 may notify an alert, for example, on a browser screen of the terminal device (user) 4_1 in FIG. 1, and may notify the alert using an e-mail. In addition, when there is an alert notification script (for example, a batch), the script may be started. The notification unit 225 notifies monitoring result information that is created by the overall management unit 221, to the terminal device (user) 4_1.

A specific example of the monitoring processing is described below. When a numerical value that is a monitoring target in business data that is newly collected is less than the alert determination threshold value in a state in which “downward” is input as the alert direction in the threshold value decision rule, the alert determination unit 2244 notifies to the terminal device 4_1 of the user that the numerical value is less than the alert determination threshold value. In the threshold value decision rule D1 of FIG. 2, “downward” is input as the alert direction. The input of “downward” as the alert direction indicates that an alert is notified when the numerical value of newly collected business data is less than the alert determination threshold value in determination information of the threshold value decision rule D1.

Here, the collection unit 223 collects uncollected business data that is stored in the file server 12 and the business DB 13 of the information processing system 1, for each certain time interval, and stores the collected business data in the input table T1 in FIG. 3.

At this time, it is assumed that the alert determination unit 2244 determines that a numerical value that is a monitoring target for each context item in the newly collected business data, for example, a stock quantity of the product name “AAA” and a stock quantity of the product name “BBB” is less than the abnormal level threshold value. After that, the notification unit 225 notifies an alert to the terminal device 4_1 of the user that the numerical value is in an abnormal level. In addition, it is assumed that the alert determination unit 2244 determines that the numerical value that is a monitoring target for each of the context items is less than the warning level threshold value and the abnormal level threshold value or more. After that, the notification unit 225 notifies an alert to the terminal device 4_1 of the user that the numerical value is in a warning level.

For example, as illustrated in the input table T1 of FIG. 3, it is assumed that a stock quantity of the product name “AAA” in a time “tx” in newly collected business data is “220”. In this case, the notification unit 225 notifies that the stock quantity of the product name “AAA” is less than the abnormal level threshold value because the abnormal level threshold value of the above-described product name “AAA” is “240”. The user executes processing in accordance with a handling procedure manual in response to the notification. Here, the handling procedure manual describes that it is desirable that the processing in response to the notification is executed urgently when an alert of an abnormal level is notified.

In addition, as illustrated in the input table T1 of FIG. 3, it is assumed that a stock quantity of the product name “BBB” in the time “tx” in newly collected business data is “700”. In this case, the notification unit 225 notifies that the stock quantity of the product name “BBB” is less than the warning level threshold value because the warning level threshold value of the above-described product name “BBB” is “720” and the abnormal level threshold value of the above-described product name “BBB” is “640”. The user executes processing in accordance with the handling procedure manual in response to the notification. Here, the handling procedure manual describes that it is desirable that the processing in response to the notification is executed when an alert of a warning level is notified. However, in the business procedure manual describes that, in a case of the notification of the alert of the warning level, the urgency and importance of the handling processing for the notification is low as compared with notification of the alert of the abnormal level.

As described above, by the notifies of two stages of alert determination threshold values, the urgency and importance of the processing to handle the above-described notification by the user can be adjusted.

A case in which “upward” is input as the alert direction is described after description of FIG. 8.

### Overall Flow of the Processing

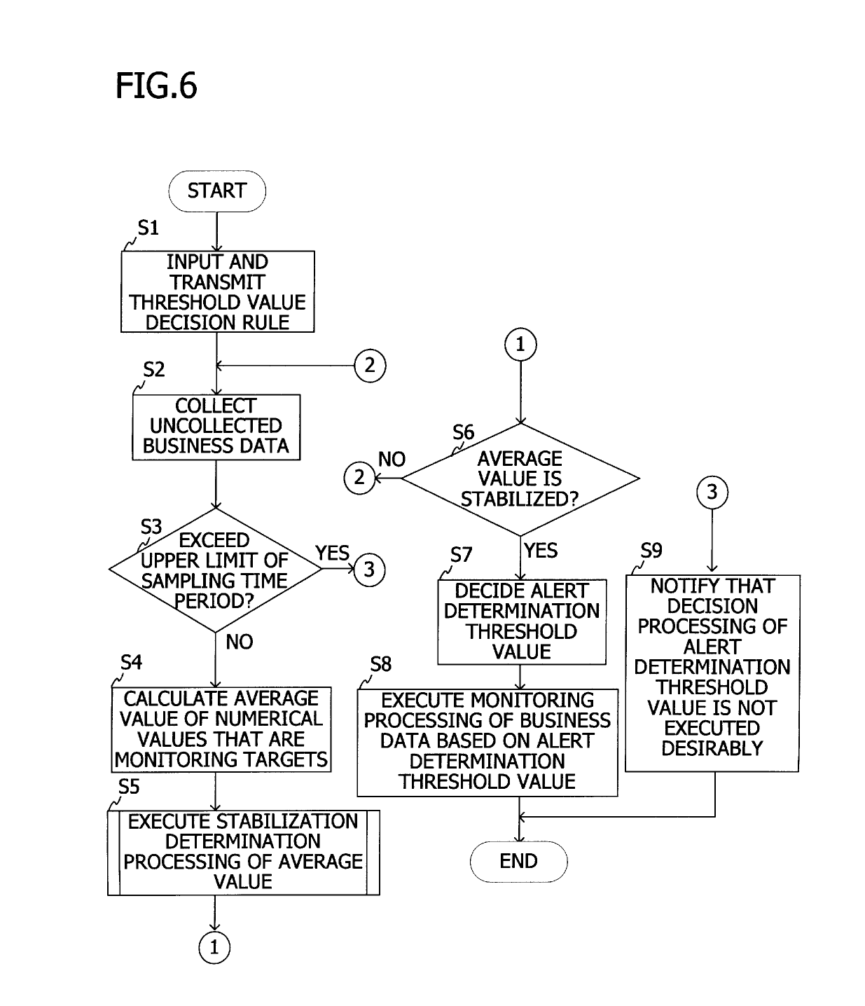

The flow of the processing of the monitoring apparatus 2 in FIG. 5 is described based on FIG. 6 with reference to FIGS. 1 to 5.

FIG. 6 is a flowchart illustrating the flow of the processing of the monitoring apparatus 2 in FIG. 5.

Step S1: The administrator of the monitoring apparatus 2 inputs the threshold value decision rule illustrated in FIG. 2 by operating the terminal device 3 and transmits the threshold value decision rule to the monitoring apparatus 2 while giving a setting instruction of a threshold value to the monitoring apparatus 2 by operating the terminal device 3.

The rule setting unit 222 in the monitoring apparatus 2 of FIG. 5 receives the threshold value decision rule and stores the threshold value decision rule in the storage device 24 (see FIG. 1) as the threshold value decision rule D1 in FIG. 2. Here, the overall management unit 221 sets an execution ending time point of Step S1 as a starting time point of an execution time period of the decision processing of an alert determination threshold value, that is, a starting time point of a sampling time period.

Step S2: The collection unit 223 collects uncollected business data that is stored in the file server 12 and the business DB 13 of the information processing system 1, for each certain time interval, in response to the setting instruction, and stores the uncollected business data in the input table T1 of FIG. 3. The certain time is, for example, 24 hours. Here, the collection unit 223 stores business data that is illustrated in the reference number A1 in FIG. 3.

Step S3: The overall management unit 221 determines whether a time period from an execution time point to a current time point of the sampling time period exceeds an upper limit of a sampling time period in the threshold value decision rule. In the case of the threshold value decision rule D1 of FIG. 2, the upper limit of the sampling time period is “one month”.

When the time period from the execution time point to the current time point of the sampling time period does not exceed the upper limit of the sampling time period in the threshold value decision rule D1 of the storage device 24 (Step S3/NO), the flow proceeds to Step S4.

Step S4: The calculation unit 2241 executes calculation processing of aggregation type in the threshold value decision rule, for a numerical value that is a monitoring target in collected business data. The numerical value that is a monitoring target is a target attribute in threshold value decision rule. The calculation unit 2241 executes the calculation processing for each context item in the threshold value decision rule. In addition, the calculation unit 2241 stores an average value for each of the context items in accordance with the calculation date. In the example of the input table T1 of FIG. 3, the input table T1 stores data having a range that is indicated in the reference number A1 at the present time. In this case, the calculation processing is not executed because there is one stock quantity having each of the product names “AAA” and “BBB.

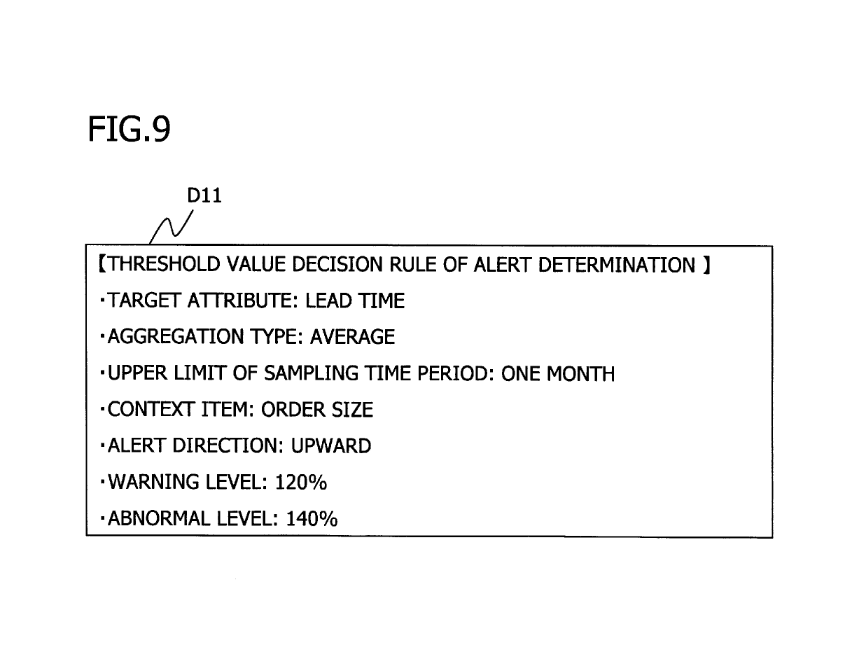

Step S5: The average value stabilization determination unit 2242 executes processing to determine whether an average value of for each of the context items is stabilized. The detail of the determination processing is described in FIGS. 8 and 9.

Step S6: The flow proceeds to Step S7 when the average value stabilization determination unit 2242 determines that the average value is stabilized (Step S6/YES), and the flow returns to Step S2 when the average value stabilization determination unit 2242 determines that the average value is not stabilized (Step S6/NO).

Here, it is assumed that the average value is not stabilized. In this case, the flow proceeds to Step S2, and the processing of Steps S2 to S6 are executed again.

In the second rotation of Step S2, the collection unit 223 collects business data of the stock quantity “345” having the product name “AAA” on the date “5/4” and business data of the stock quantity “870” having the product name “BBB” on the date “5/4” as uncollected business data, from the file server 12. In addition, as described in Step S2, the collection unit 223 stores the contents of the business data in the input table T1 of FIG. 3. As a result, the collection unit 223 stores the business data that illustrated in the reference number A2 of FIG. 3.

Next, the processing of Step S3 is executed, and the flow proceeds to Step S4 when “NO” is determined in Step S3.

In Step S4, the calculation unit 2241 calculates an average value of the stock quantities “275” and “345” having the product name “AAA” as two unit business data portions. In addition, the calculation unit 2241 calculates an average value of the stock quantities “880” and “870” having the product name “BBB” as two unit business data portions. The calculation processing is described in FIG. 5, and the description is omitted here.

By repeating the processing that is described in Steps S2 to S6, business data is sequentially stored as illustrated in FIG. 3, and, an average value of numerical values that are monitoring targets is updated as illustrated in FIG. 4. For example, when the third rotation of Step S2 is executed, the collection unit 223 collects business data of the stock quantity “280” having the product name “AAA” on the date “5/5” and business data of the stock quantity “860” having the product name “BBB” on the date “5/5” as uncollected business data, from the file server 12. In addition, the collection unit 223 stores the contents of the business data in the input table T1 of FIG. 3 (see the reference number A3 in FIG. 3)

Next, in Step S4, the calculation unit 2241 calculates an average value of the stock quantities “275”, “345”, and “280” having the product name “AAA” as three unit business data portions. In this case, the calculation unit 2241 calculates “300 ((275+345+280)/3)” as the average value. In addition, the calculation unit 2241 stores the date “5/5” on which the average value is calculated in the date field as illustrated in the aggregation table T2 of FIG. 4. In addition, the calculation unit 2241 stores the product name “AAA” in the field of the context 1 and stores the calculated average value “300” in the average value field. The calculation unit 2241 calculates and stores an average value for stock quantities having the product name “BBB”, similarly to the stock quantities having the product name “AAA”.

The flow proceeds to Step S7 when the average value stabilization determination unit 2242 determines that the average value that is calculated by the calculation unit 2241 is stabilized (Step S6/YES) after repeating the processing of Steps S2 to S6.

Step S7: The threshold value decision unit 2243 decides an alert determination threshold value for each context item, based on the latest average value that is calculated by the calculation unit 2241, that is, the reference value. The decision processing of an alert determination threshold value is described in FIG. 5, and the description is omitted here.

Step S8: The alert determination unit 2244 executes the monitoring processing of the business data based on the alert determination threshold value that is decided by the threshold value decision unit 2243. The monitoring processing of the business data is described in FIG. 5, and the description is omitted here.

In Step S3, the flow proceeds to Step S9 when the overall management unit 221 determines that the time period from the execution time point to the current time point of the sampling time period exceeds the upper limit of the sampling time period in the threshold value decision rule (Step S3/YES).

Step S9: The overall management unit 221 notifies to the terminal device 3 of the administrator that the decision processing of an alert determination threshold value is not executed desirably. When the time period from the execution time point to the current time point of the sampling time period exceeds the upper limit of the sampling time period in the threshold value decision rule, an average value of numerical values that are monitoring targets in the business data is not stabilized even in case in which sampling is performed on the numerical values during the upper limit time period. In such a case, it is desirable that review of the contents of the threshold value decision rule is promoted. Therefore, the processing in Step S9 is executed. The administrator reviews the contents of the threshold value decision rule in response to the notification.

### Flow of the Stabilization Determination Processing of an Average Value

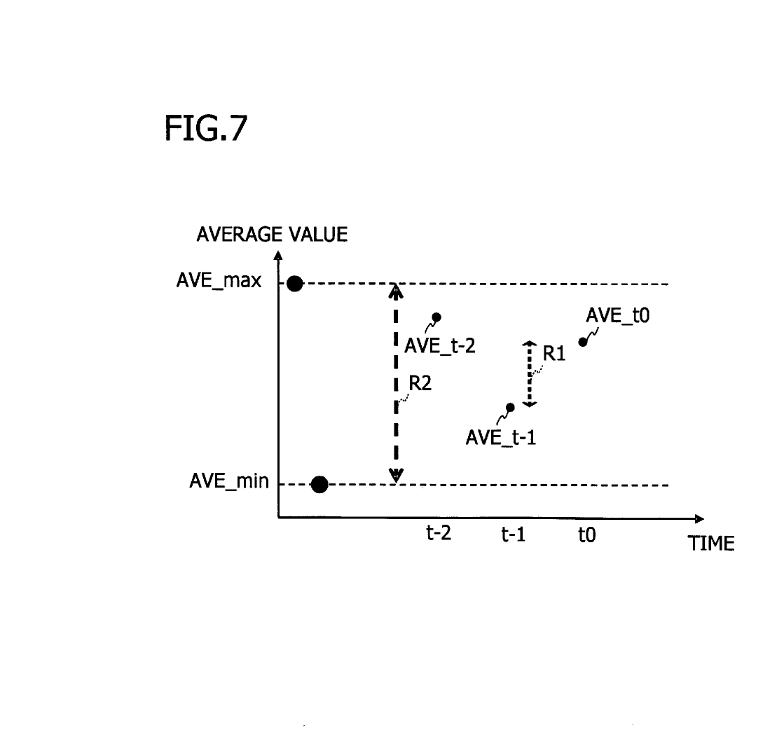

A flow of the stabilization determination processing of an average value of Step S5 in FIG. 6 is described based on FIGS. 7 and 8 with reference to FIGS. 4 and 5.

FIG. 7 is a graph schematically illustrating the flow of the stabilization determination processing of an average value in FIG. 6. Here, the vertical axis indicates an average value of numerical values of a target attribute of a context item, which is calculated by the calculation unit 2241. The horizontal axis indicates the calculation time. In the description of FIGS. 7 and 8, the average value of numerical values of a target attribute of a context item, which is calculated by the calculation unit 2241, is referred to as an average value as appropriate. Here, as the context item, the product name “AAA” is illustrated.

A reference number AVE_max indicates the maximum average value out of average values that are calculated by the calculation unit 2241, and a reference number AVE_min indicates the minimum average value out of the average values that are calculated by the calculation unit 2241. Reference numbers AVE_t−2, AVE_t−1, and AVE_t0 respectively indicates average values that are calculated by the calculation unit 2241 in times t−2, t−1, and t0. In the example of FIG. 6, each interval of times (t−2, t−1, and t0) is 24 hours. The examples of the average values respectively correspond to the average values (AVE_t−2, AVE_t−1, and AVE_t0) having the product name “AAA” that is stored in the field of context 1 on the generation dates t−2, t−1, and t0 of the aggregation table T2 in FIG. 4.

FIG. 8 is a flowchart illustrating a flow of the stabilization determination processing of an average value in FIG. 6. It is assumed that the stabilization determination processing of an average value is executed in the time t0 in the flowchart of the FIG. 8.

Step S51: The average value stabilization determination unit 2242 determines whether the maximum average value and the minimum average value are not equal among the average values that are calculated by the calculation unit 2241. In the example of FIG. 7, it is determined whether the maximum average value AVE_max and the minimum average value AVE_min are not equal. The determination formula (formula 1) is represented as follows.

maximum average value AVE_max≠minimum average value AVE_min (formula 1)

The determination processing is executed in order to avoid that it is erroneously determined that an average value is stabilized in Step S53 described later when the average value itself is not changed in the initial stage of the average value stabilization determination processing, and the determination processing may not be executed.

The flow proceeds to Step S52 when the maximum average value and the minimum average value are not equal (Step S51/YES).

Step S52: The average value stabilization determination unit 2242 determines whether the latest average value that is calculated by the calculation unit 2241 (also referred to as the most recent average value) is between two average values that are calculated just before the latest average value calculated by the calculation unit 2241. That is, the average value stabilization determination unit 2242 determines whether the latest average value is between a first average value that is calculated just before the latest average value and a second average value that is calculated just before the first average value. In the example of FIG. 7, the latest average value is the average value AVE_t0 in the time to, the first average value is the average value AVE_t−1 in the time t−1, and the second average value is the average value AVE_t−2 in the time t−2.

The determination formula when “average value AVE_t−2<average value AVE_t−1” is satisfied is represented in the following formula 2.

average value AVE_{—}t−2<average value AVE_{—}t0<average value AVE_{—}t−1 (formula 2)

The determination formula when “average value AVE_t−1<average value AVE_t−2” is satisfied is represented in the following formula 2′.

average value AVE_{—}t−1<average value AVE_{—}t0<average value AVE_{—}t−2 (formula 2′)

The determination processing is executed in order to avoid that it is erroneously determined that an average value is stabilized in Step S53 described later when variation in average values becomes small in case in which the average value increases gradually or decreases gradually, and the determination processing may not be executed.

The flow proceeds to Step S53 when the average value stabilization determination unit 2242 determines that the latest average value that is calculated by the calculation unit 2241 is between the two average values that are calculated just before the latest average value by the calculation unit 2241 (Step S52/YES).

Step S53: The average value stabilization determination unit 2242 determines whether variation of the latest average value that is calculated by the calculation unit 2241 is within 1% of the maximum amount of a variation range. Here, variation of the latest average value is a difference absolute value of the average value AVE_t0 in the time t0 and the average value AVE_t−1 in the time t−1 (see the reference number R1 in FIG. 7), and the maximum amount of the variation range is a difference value of the maximum average value AVE_max and the minimum average value AVE_min (see a reference number R2 in FIG. 7).

The determination formula is represented by the following formula 3.

(|average value AVE_{—}t0-average value AVE_{—}t−1|)/(maximum average value AVE_max−minimum average value AVE_min)≦0.01 (formula 3)

That is, the average value stabilization determination unit 2242 determines whether a difference absolute value of the latest average value AVE_t0 and the first average value AVE_t−1 is within a certain range for the difference value of the maximum average value AVE_max and the minimum average value AVE_min. The certain range is 1% (0.01) in the example.

The determination processing in Step S53 is the major determination processing in the average value determination processing.

When the average value stabilization determination unit 2242 determines that variation of the latest average value that is calculated by the calculation unit 2241 is within 1% of the maximum amount of the variation range (Step S53/YES), the flow proceeds to Step S54, and it is determined that the average value is stabilized (Step S54). That is, the average value stabilization determination unit 2242 determines that the average value is stabilized and determines the reference value. In this case, “YES” is determined in Step S6 of FIG. 6, and the flow proceeds to Step S7. At this time, the average value stabilization determination unit 2242 determines the latest average value AVE_t0 as the reference value.

On the other hand, when the average value stabilization determination unit 2242 determines “NO” in Steps S51 to S53 in FIG. 8, the flow proceeds to Step S55, and it is determined that the average value is not stabilized (Step S55). In this case, “NO” is determined in Step S6 in FIG. 6, the flow returns to Step S2.

The average value stabilization determination unit 2242 executes the stabilization determination processing of an average value, which is described in FIGS. 7 and 8, on an average value of numerical values of a target attribute for each context item.

As described in FIGS. 5 to 8, the monitoring apparatus 2 determines whether an average value of the numerical values that are monitoring targets are stabilized, and executes the monitoring processing of the numerical value using the average value that is determined to be stabilized as a reference.

In the threshold value decision rule D1 of FIG. 2, the administrator inputs “downward” as the alert direction in order to monitor a safe stock quantity of the product. When the administrator desires to monitor an excess stock quantity of the product, the administrator inputs “upward” as the alert direction in the threshold value decision rule in Step S1 of FIG. 6. In addition, the administrator inputs, for example, “120%” as the warning level and “140%” as the abnormal level.

After the processing in Steps S2 to S7 of FIG. 6 is executed based on the threshold value decision rule, the flow proceeds to Step S8. In this Step S8, the alert determination unit 2244 determines whether a numerical value that is a monitoring target in newly collected business data exceeds the alert determination threshold value because “upward” is input as the alert direction in the threshold value decision rule.

In the first embodiment, the monitoring apparatus determines whether an average value of numerical values that are monitoring targets in business data is stabilized, and decides an alert determination threshold value using the average value that is determined to be stabilized as a reference value. The reference value corresponds to the key performance evaluation indicator. By the decision, an optimal alert determination threshold value is decided rapidly for the numerical value that is a monitoring target, that is, the business contents that are the monitoring targets.

For example, by calculating an average value of numerical values that are monitoring targets during a certain time period, an alert determination threshold value of the numerical value may be decided based on the average value. However, the numerical value that is a monitoring target is a numerical value that is related to the contents of business that is performed by hand, so that variation in the numerical values is large. That is, when numerical values are merely averaged during the certain time period, the average value is directly affected by the variation in the numerical values especially at the monitoring starting time point. As a result, an alert determination threshold value of the numerical values is affected by the variation, so that it is difficult to decide an optimal alert determination threshold value.

On the other hand, in the first embodiment, it is determined whether an average value of numerical values that are monitoring targets is stabilized based on variation in the numerical values, and an alert determination threshold value is decided using the average value that is determined to be stabilized as a reference value. Therefore, it can be avoided that the alert determination threshold value of the numerical value is affected by the above-described variation because the monitoring apparatus does not determine that the average value is stabilized when the variation occurs. As a result, an appropriate alert determination threshold value can be decided.

In addition, similarly, an optimal alert determination threshold value can be decided rapidly for the business contents that are monitoring targets even when there are various types of numerical values that are the monitoring targets. As a result, information that is related to a numerical value and attribute information of business data, that is, information that indicates a stock quantity of a certain product (attribute information) falls below a safe stock quantity in the above-described example, can be notified appropriately.

When the administrator inputs a threshold value decision rule, the monitoring apparatus automatically decides an alert determination threshold value of a numerical value that is a monitoring target. Therefore, the administrator does not need to decide an alert determination threshold value by himself/herself, based on his/her own experience and the previous performance, and can reduce the burden of the administrator because the administrator do without setting of the threshold value to the monitoring apparatus. Especially, when there are various types of numerical values that are monitoring targets, the burden of the administrator is significantly reduced.

In addition, the administrator does not need determination know-how of an alert determination threshold value because the administrator does not need to decide the alert determination threshold value by himself/herself based on his/her own experience and the previous performance.

In addition, the alert determination threshold value is not needed to be set to the monitoring apparatus after the administrator obtains determination know-how of the alert determination threshold value in a new business system because the administrator does not need the above-described determination know-how of the alert determination threshold value. That is, the administrator does not need to monitor and operate the business system and the monitoring apparatus, check that variation in numerical values that are monitoring targets varies, and decide an alert determination threshold value.

Therefore, a time to obtain the determination know-how is not needed, so that a monitoring operation time is not needed. As a result, the monitoring processing of business data processed by the business system is started rapidly, so that an optimal alert determination threshold value can be decided smoothly. That is, an introduction time and an introduction cost of the monitoring apparatus can be reduced.

The monitoring apparatus decides an alert determination threshold value of a numerical value that is a monitoring target independently for each context item of a threshold value decision rule, and can decide an alert determination threshold value for various types of numerical values even when the monitoring apparatus monitors the various types of numerical values in the business system.

In addition, numerical values that are monitoring targets can be categorized for each context item by setting the context item for each area such as sales area of the product or for every age such as year of manufacture of the product, in addition for each item such as a product name. In addition, the numerical values that are monitoring targets can be categorized for each time by setting the context item along with the time axis. The time axis indicates, for example, every month, each day of the week such as weekday and holiday, each time period such as morning and evening, each business peak time period such as busy season or off-season. As a result, numerical values that are monitoring targets can be analyzed and monitored from various aspects.

In addition, the monitoring apparatus decides an alert determination threshold value merely by inputting a simple numerical value as the abnormal level and the warning level in the threshold value decision rule, so that the administrator can reduce the burden of input of the threshold value decision rule.

### Second Embodiment

In the first embodiment, the inventory management system is described as the information processing system 1 in FIG. 1, and in a second embodiment, a courier cargo management system (hereinafter, referred to as a home delivery management system) that is an example of a delivery management system is described as an example.

### System

When the information processing system 1 is the home delivery management system, business data includes an identifier that identifies a delivery article (hereinafter, referred to as a case ID), an order date on which a delivery order of the delivery article is accepted, the size of the delivery article (hereinafter, referred to as an order size), and a lead time. The lead time is a time from reception of the delivery article to delivery of the delivery article to the destination by a delivery personnel who delivers the delivery article. A name of the delivery personnel of the delivery article may be included in the business data.

The server device 11 of the information processing system 1 collects the business data using a small-size portable terminal that is carried by the delivery personnel and a terminal device in an office of a delivery business operator.

The server device 11 collects, for example, business data including a case ID “102”, an order date “02/10 09:00”, an order size “large”, and a lead time “4.2” and stores the business data in the file server 12.

FIG. 9 is a diagram schematically illustrating another example of the threshold value decision rule in FIG. 1.

The administrator of the monitoring apparatus 2 in FIG. 1 inputs a threshold value decision rule by operating the terminal device 3 and transmits the threshold value decision rule to the monitoring apparatus 2. In the example of the threshold value decision rule D11 of FIG. 9, the administrator inputs “lead time” as the target attribute, “average” as the aggregation type, and “one month” as the upper limit of the sampling time period by operating the terminal device 3. In addition, the administrator inputs “order size” as the context item, “upward” as the alert direction, “120%” as the warning level, and “140%” as the abnormal level by operating the terminal device 3. The terminal device 3 transmits the threshold value decision rule including the input contents to the monitoring apparatus 2.

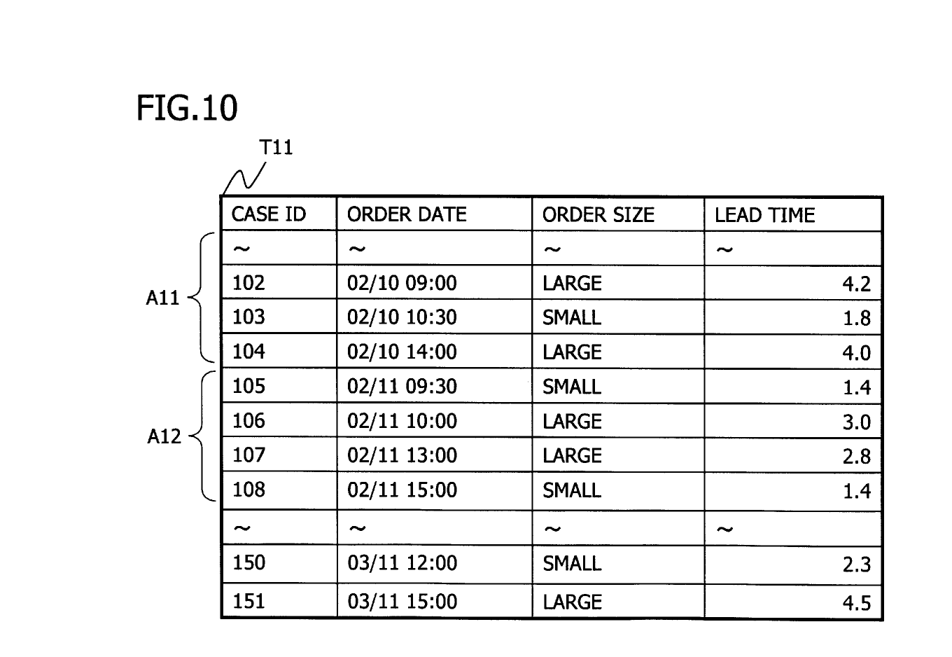

FIG. 10 is a diagram illustrating another example of the input table T1 in FIG. 1. In the input table T11, a state is schematically illustrated in which the monitoring apparatus 2 in FIG. 1 stores business data that is newly collected from the information processing system 1 in a table format in the storage device 24.

The input table T11 includes a case ID field, an order date field, an order size field, and a lead time (time) field. The case ID field stores a case ID of the delivery article, the order date field stores an order date of the delivery article, the order size field stores an order size of the delivery article, and the lead time field stores a lead time of the delivery article.

The input table T11 stores, for example, a date “02/10 09:00”, an order size “large”, and a lead time “4.2”.

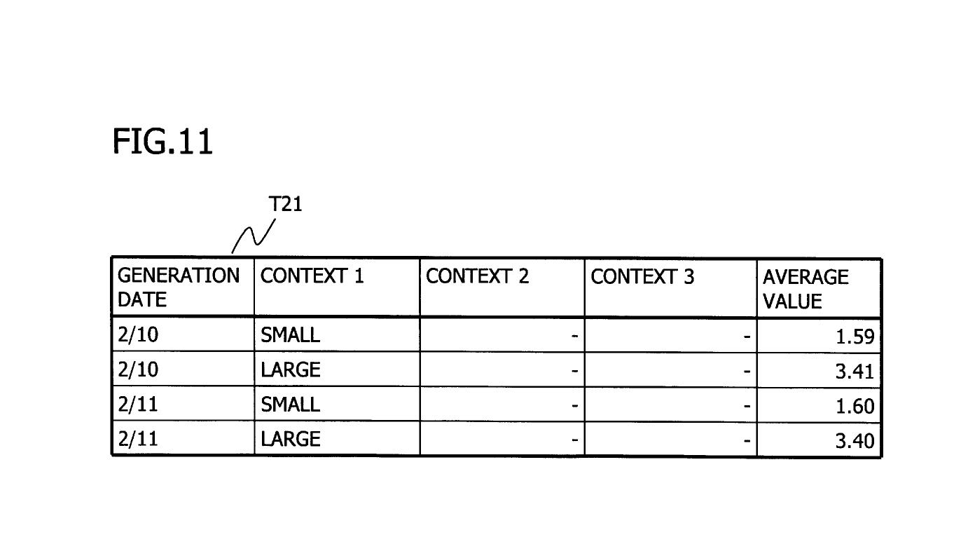

FIG. 11 is a diagram illustrating another example of the aggregation table T2 in FIG. 1. The aggregation table T21 is a table that is generated by the monitoring apparatus 2 based on the threshold value decision rule D11 in FIG. 9 and the input table T11 in FIG. 10. Each of the fields is similar to that of the aggregation table T2 in FIG. 4.

A generation date field indicates a date on which a certain line of the table is generated. Fields of contexts 1, 2, and 3 store the contents of business data, which correspond to context items of a threshold value decision rule. In the example of the threshold value decision rule D11 in FIG. 9, the context item is “order size”. In addition, in the example of the above-described business data, the content that corresponds to “order size” is “small” or “large” of the order size. The average value field stores an average value of numerical values of a target attribute for each context item in the collected business data. In the example of the threshold value decision rule D11 of FIG. 9, the target attribute is “lead time”.

The aggregation table T2 stores, for example, an average value “1.59” of lead times of an order size “small” on a date “2/10” that is stored in the generation date field.

### Overall Flow of the Processing

A flow of the processing of the monitoring apparatus 2 is described using the flowchart in FIG. 6 with reference to FIGS. 1, 5, 9, and 10. The function of the monitoring apparatus 2 is substantially the same as that of the first embodiment, and different from that of the first embodiment in terms of the contents of the threshold value decision rule D1, the input table T1, and the aggregation table T2.

Step S1: The administrator of the monitoring apparatus 2 inputs the threshold value decision rule described in FIG. 9 by operating the terminal device 3 and transmits the threshold value decision rule to the monitoring apparatus 2.

Step S2: The collection unit 223 collects uncollected business data that is stored in the file server 12 and the business DB 13 of the information processing system 1 for each certain time intervals, and stores the collected uncollected business data in the input table T11 of FIG. 10.

The collection unit 223 collects, for example, the business data that is stored in the file server 12 for each 24 hours, and stores the business data in the input table T11 as illustrated in a reference number A11 and a reference number A12 of the input table T11 in FIG. 10.

Step S3: The overall management unit 221 determines whether a time period from an execution time point to a current time point of a sampling time period exceeds an upper limit of a sampling time period in the threshold value decision rule. In the example of the threshold value decision rule D11 of FIG. 9, the upper limit of the sampling time period is “one month”.

Step S4: The calculation unit 2241 executes calculation processing of an aggregation type in the threshold value decision rule for a numerical value that is a monitoring target in the collected business data.

The numerical value that is a monitoring target is a target attribute in the threshold value decision rule. The calculation unit 2241 executes the calculation processing for each context item in the threshold value decision rule. In addition, the calculation unit 2241 stores the calculation result.

In the threshold value decision rule D11 of FIG. 9, the aggregation type is “average”, the context item is “order size”, and the target attribute is “lead time”. In this case, the calculation unit 2241 calculates an average value of numerical values of the target attribute “lead time” in the threshold value decision rule D1, in the business data that is stored in the input table T11 of FIG. 10 by the collection unit 223. The calculation unit 2241 executes calculation processing of the average value for each of the context items of “order size”, and stores the average value in the aggregation table T21 of FIG. 11.

Step S5: The average value stabilization determination unit 2242 executes processing to determine whether an average value for each of the context items is stabilized. The determination processing is described in FIGS. 7 and 8, and the description is omitted here.

Step S6: The flow proceeds to Step S7 when the average value stabilization determination unit 2242 determines that the average value is stabilized (Step S6/YES), and the flow proceeds to Step S2 when the average value stabilization determination unit 2242 determines that the average value is not stabilized (Step S6/NO).

The flow proceeds to Step S7 when the average value stabilization determination unit 2242 determines that the average value that is calculated by the calculation unit 2241 is stabilized (Step S6/YES) after repeating the processing of Steps S2 to S6.

Step S7: The threshold value decision unit 2243 decides an alert determination threshold value for each of the context items, based on the latest average value that is calculated by the calculation unit 2241, that is, the reference value.

Here, it is assumed that the reference value (lead time) having the order size “small” that is the context item is “1.6”, and the reference value (lead time) having the order size “large” that is the context item is “3.4”. In addition, in the threshold value decision rule D11 of FIG. 9, a numerical value of the warning level is 1.2 (120%), and a numerical value of the abnormal level is 1.4 (140%).

In this case, the threshold value decision unit 2243 multiplies the reference value “1.6” of the order size “small” by the numerical value (1.2) of the warning level, and decides a warning level threshold value of the order size “small” as “1.92”. In addition, the threshold value decision unit 2243 multiplies the reference value “1.6” of the order size “small” by the numerical value (1.4) of the abnormal level, and decides an abnormal level threshold value of the order size “small” as “2.24”. Similarly, the threshold value decision unit 2243 decides a warning level threshold value of the order size “large” as “4.08”, and decides an abnormal level threshold value of the order size “large” as “4.76”.

Step S8: The alert determination unit 2244 executes the monitoring processing of the business data based on the alert determination threshold values that are determined by the threshold value decision unit 2243.

A specific example of the monitoring processing is described below. When a numerical value that is a monitoring target in newly collected business data exceeds the alert determination threshold value in a state in which “upward” is input as the alert direction in the threshold value decision rule, the alert determination unit 2244 notifies to the terminal device 4_1 of the user that the numerical value exceeds the alert determination threshold value. In the threshold value decision rule D11 of FIG. 9, “upward” is input as the alert direction. The input of “upward” as the alert direction indicates that an alert is notified when a numerical value in newly collected business data exceeds the alert determination threshold value in determination information of the threshold value decision rule D11.

Here, the collection unit 223 collects uncollected business data that is stored in the file server 12 and the business DB 13 of the information processing system 1, for each certain time interval, and stores the collected business data in the input table T11 of FIG. 10. At this time, it is assumed that the alert determination unit 2244 determines that a numerical value that is a monitoring target for each context item in the newly collected business data exceeds the abnormal level threshold value. The notification unit 225 notifies an alert to the terminal device 4_1 of the user that the numerical value is in the abnormal level. In addition, it is assumed that the alert determination unit 2244 determines that the numerical value that is a monitoring target for each of the context items is less than or equal to the abnormal level threshold value and more than the warning level threshold value. The notification unit 225 notifies an alert to the terminal device 4_1 of the user that the numerical value is in a warning level. The numerical value is, for example, a lead time of the order size “small” and a lead time of the order size “large”. The notification unit 225 also notifies a case ID that identifies the lead time in addition to the above-described notification. The notification unit 225 may notify the name of the delivery personnel, which is identified by the case ID in addition to the case ID.

For example, as illustrated in the input table T11 of FIG. 10, it is assumed that a lead time of the order size “small” of a case ID “150” in newly collected business data is “2.3”. In this case, the alert determination unit 2244 notifies that the lead time of the order size “small” of the case ID “150” exceeds the abnormal level because an abnormal level threshold value of the above-described order size “small” is “2.24”. In addition, as illustrated in the input table T11, it is assumed that a lead time of the order size “large” of a case ID “151” in the newly collected business data is “4.5”. In this case, the alert determination unit 2244 notifies that the lead time of the order size “large” of the case ID “151” exceeds the warning level because a warning level threshold value of the above-described order size “large” is “4.08”, and an abnormal level threshold value of the above-described order size “large” is “4.76”. The administrator executes processing in accordance with the handling procedure manual in response to the notification.

In the second embodiment, the monitoring apparatus 2 can monitor various types of monitoring data to be processed by the business systems merely by changing a threshold value decision rule.

In addition, the monitoring apparatus 2 can be applied to a production management system or a management system of a telephone appointment business.

In the production management system, when quality management of a certain product is performed, the business data is a defect rate of the product. The defect rate is obtained by dividing the number of defective products per unit time by the number of manufactured products. In addition, the administrator inputs a target attribute “defect rate”, an aggregation type “average”, a context item “product name”, and an alert direction “upward” as a threshold value decision rule. Values of an upper limit of a sampling time period, a warning level, and an abnormal level are input depending on the business contents. At this time, the input is performed so that “1<numerical value of the warning level<numerical value of the abnormal level” is satisfied.

When the management of an order rate is performed in the management system of the telephone appointment business, the business data includes the name of a staff member in the telephone appointment business and an order rate of the staff member. The order rate is obtained by dividing the number of orders of the staff member per unit time by the number of callings in total.

In addition, the administrator inputs a target attribute “order rate”, an aggregation type “average”, a context item “name of staff member”, and an alert direction “downward” as a threshold value decision rule. Values of an upper limit of a sampling time period, a warning level, and an abnormal level are input depending on the business contents. At this time, the input is performed so that “1>numerical value of the warning level>numerical value of the abnormal level” is satisfied.

### Third Embodiment

As described in the first and second embodiments, the monitoring apparatus 2 decides an alert determination threshold value and executes the monitoring processing, and the alert determination threshold value may be inappropriately decided due to various factors.

In the example of the inventory management system that is described in the first embodiment, for example, when a shop scale is expanded or reduced, a safe stock quantity and an excess stock quantity of a product vary. In addition, when inventory management of a product such as ice cream and soft drink, the volume of sales of which varies greatly depending on the season is performed, a safe stock quantity and an excess stock quantity of the product vary depending on the season. In order to perform appropriate inventory management for the variation, it is desirable that the above-described alert determination threshold value is re-decided.

In addition, in the example of the home delivery management system that is described in the second embodiment, for example, when area of responsibility for the delivery personnel is a heavy snow area, the lead time varies greatly throughout the year because a road condition is deteriorated in the winter time as compared with another time period. In such a case, in order to perform appropriate lead time management for the variation, it is desirable that the above-described alert determination threshold value is re-decided.

Therefore, in a third embodiment, the monitoring apparatus 2 that re-decides the alert determination threshold value is described.

The collection unit 223 in FIG. 5 sequentially collects business data after the average value stabilization determination unit 2242 determines that an average value is stabilized. The calculation unit 2241 calculates the average value of numerical values in the collected business data, the average value stabilization determination unit 2242 determines whether an evaluation result of a determined threshold value is notified based on the average value of the numerical values. Here, the average value stabilization determination unit 2242 determines whether a difference absolute value of the latest average value and the stabilized average value is within a certain range for a difference value of the maximum average value and the minimum average value. In addition, when the average value stabilization determination unit 2242 determines that the difference absolute value is not within the certain range, the notification unit 225 notifies the evaluation result of the determined threshold value to the terminal device 4_1 of the user (see the reference number F3).

### Flow of the Re-Decision Processing of an Alert Determination Threshold Value

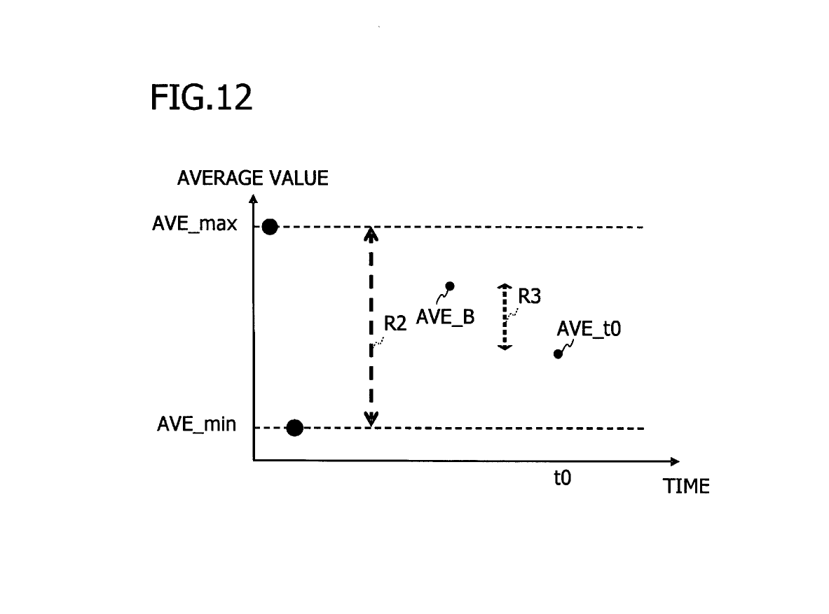

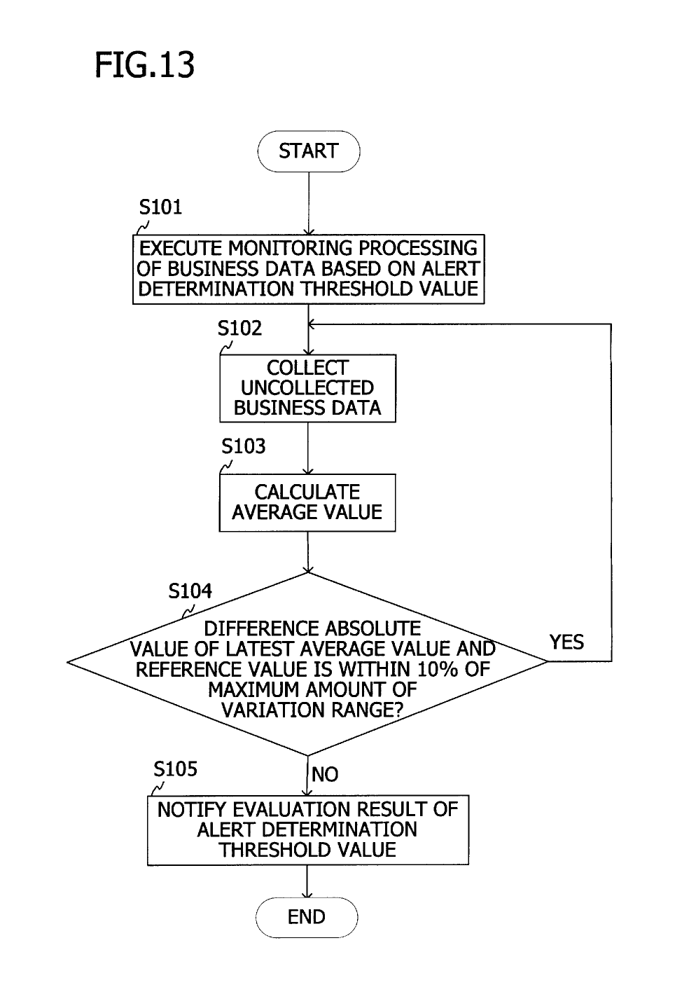

A flow of the re-decision processing of an alert determination threshold value is described based on FIG. 12 and FIG. 13 with reference to FIG. 5.

FIG. 12 is a graph schematically illustrating a flow of the re-decision processing of an alert determination threshold value. Here, the vertical axis indicates an average value of numerical values of a target attribute of a context item, which is calculated by the calculation unit 2241. The horizontal axis indicates the calculation time. In the description of FIGS. 12 and 13, the average value of numerical values of a target attribute of a context item, which is calculated by the calculation unit 2241, is referred to as an average value as appropriate. Hereinafter, the product name “AAA” of the context item that is described in the first embodiment is described as an example.

A reference number AVE_t0 indicates an average value that is calculated by the calculation unit 2241 in a time t0. A reference number AVE_B indicates a reference value of the average value. In the above-described example, the reference value AVE_B is “300”.

FIG. 13 is a flowchart illustrating a flow of the re-decision processing of an alert determination threshold value. In the description of FIG. 13, it is assumed the threshold value decision unit 2243 in FIG. 5 has already decided an alert determination threshold value.

Processing in Steps S101 to S103 that are described later is similar to the processing that is described in Steps S8, S2, and S4 of FIG. 6, and the detailed description is omitted here.

Step S101: The alert determination unit 2244 in FIG. 5 executes the monitoring processing of business data based on the alert determination threshold value that is decided by the threshold value decision unit 2243.

Step S102: The collection unit 223 collects uncollected business data that is stored in the file server 12 and the business DB 13 of the information processing system 1 for each certain time interval, and stores the collected business data in the input table T1 of FIG. 3.

Step S103: The calculation unit 2241 executes the calculation processing of an average value for the collected numerical values that are monitoring targets in the business data. In the above-described example, an average value is calculated for a stock quantity of the product name “AAA”. As described in Step S103, the calculation unit 2241 calculates an average of numerical values in the collected business data.

Step S104: The average value stabilization determination unit 2242 in FIG. 5 determines whether a difference absolute value of the latest average value AVE_t0 and the reference value AVE_B (see the reference number R3 in FIG. 12) is within 10% of the maximum amount of the variation range (see the reference number R2 in FIG. 12).

The determination formula is represented by the following formula 4.

(|average value AVE_{—}t0−reference value AVE_{—}B|)/(maximum average value AVE_max−minimum average value AVE_min)≦0.1 (formula 4)

That is, the average value stabilization determination unit 2242 determines whether the difference absolute value of the latest average value AVE_t0 and the reference value AVE_B is within a certain range for the difference value of the maximum average value and the minimum average value. In the above-described example, the certain range is 10% (0.1).

The flow returns to Step S102 when the average value stabilization determination unit 2242 determines that the difference absolute value of the latest average value and the reference value AVE_B is within 10% of the maximum amount of the variation range (Step S104/YES).

The flow proceeds to Step S105 when the average value stabilization determination unit 2242 determines that the difference absolute value of the latest average value and the reference value AVE_B is not within 10% of the maximum amount of the variation range (Step S104/NO).

Step S105: The notification unit 225 notifies, to the terminal device 3 of the administrator, an evaluation result of an alert determination threshold value, which indicates that the difference absolute value of the latest average value and the reference value AVE_B is not within 10% of the maximum amount of the variation range. The administrator recognizes that the current alert determination threshold value is not appropriate, by the notification, and inputs a threshold value decision rule again (see Step S1 in FIG. 6). The monitoring apparatus 2 executes the processing of Step S2 and subsequent steps in FIG. 6 again and re-decides an alert determination threshold value.

The average value stabilization determination unit 2242 executes processing to determine whether the re-decision of an alert determination threshold value, which is described in FIGS. 12 and 13 is performed, for an average value of numerical values of a target attribute for each context item.

In the third embodiment, for example, an inappropriate alert determination threshold value that is caused by variation of a surrounding environment of the business system can be automatically determined, and an evaluation result of the alert determination threshold value can be notified to the administrator. Therefore, the administrator inputs a threshold value decision rule again, and causes the monitoring apparatus 2 to re-decide an alert determination threshold value. As a result, an optimal alert determination threshold value can be always maintained for a numerical value that is a monitoring target, that is, the business contents that are the monitoring targets.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A monitoring apparatus that monitors a numerical value in business data to be processed by an information processing system that executes business processing, the monitoring apparatus comprising:
a storage unit that stores a threshold value of the numerical value that is a monitoring target in the business data; and
a control unit that collects the business data from the information processing system and determines whether an alert is notified based on a comparison result of the numerical value in the business data and the threshold value, wherein
the control unit collects a plurality of the numerical values that are the monitoring target based on collection target information of the threshold value decision rule which is predetermined, in response to a setting instruction of the threshold value, calculates an average value of the numerical values for each predetermined time interval, determines whether the average value is stabilized based on variation of a plurality of the average values, and stores the threshold value that is determined based on the stabilized average value in the storage unit when it is determined that the average value is stabilized.

2. The monitoring apparatus according to claim 1, wherein
the control unit collects a plurality of the numerical values that are the monitoring target, calculates an average value of the numerical values for each of the time intervals, stores the average value in the storage unit, determines whether a difference absolute value between a latest average value and a previous average value that is calculated just before the latest average value is within a certain range for a difference value between a maximum average value and a minimum average value, and determines that the average value is stabilized when it is determined that the difference absolute value is within the certain range.

3. The monitoring apparatus according to claim 1, wherein
the control unit collects a plurality of the numerical values that are the monitoring target, calculates an average value of the numerical values for each of the time intervals, stores the average value in the storage unit, determines whether a maximum average value and a minimum average value are not equal, determines whether a latest average value is between a first average value that is calculated just before the latest average value and a second average value that is calculated just before the first average value when it is determined that the maximum average value and the minimum average value are not equal, determines whether a difference absolute value between the latest average value and the first average value is within a certain range for a difference value between the maximum average value and the minimum average value when it is determined that the latest average value is between the first average value and the second average value, and determines that the average value is stabilized when it is determined that the difference absolute value is within the certain range.

4. The monitoring apparatus according to claim 1, wherein
the control unit determines the threshold value based on the stabilized average value and threshold value decision information of the threshold value decision rule,
when determination information of the threshold value decision rule indicates that the alert is notified in case in which a numerical value in newly collected business data is less than the threshold value, notifies the alert when the numerical value in the newly collected business data is less than the determined threshold value, or when the determination information indicates that the alert is notified in case in which the numerical value in the newly collected business data exceeds the threshold value, notifies the alert when the numerical value in the newly collected business data exceeds the determined threshold value.

5. The monitoring apparatus according to claim 4, wherein
the control unit collects the business data after the average value is stabilized, calculates an average value of numerical values in the collected business data, and determines whether an evaluation result of the determined threshold value is notified, based on the average value of the numerical values.

6. The monitoring apparatus according to claim 5, wherein
the control unit determines whether a difference absolute value between a latest average value and the stabilized average value is within a certain range for a difference value between a maximum average value and a minimum average value, and notifies an evaluation result of the determined threshold value when it is determined that the difference absolute value is not within the certain range.

7. The monitoring apparatus according to claim 4, wherein
the control unit calculates an average value of numerical values that correspond to attribute information that is identified by identification information that uniquely identifies attribute information of the numerical value in the threshold value decision rule, and determines the threshold value of the numerical values.

8. A computer-readable, non-transitory recoding medium having stored therein a program for causing a computer to execute a digital signature process comprising:
collecting a plurality of numerical values that are a monitoring target based on collection target information of a threshold value decision rule which is predetermined, in response to a setting instruction of the threshold value, calculating an average value of the numerical values for each predetermined time interval, determining whether the average value is stabilized based on variation of a plurality of the average values, and storing the threshold value that is determined based on the stabilized average value in a storage unit when it is determined that the average value is stabilized; and
determining whether an alert is notified, based on a comparison result of a numerical value in newly collected business data and the determined threshold value.

9. The medium according to claim 8, wherein
in the processing to determine whether the average value is stabilized, calculating an average value of the numerical values for each of the time intervals, storing the average value in the storage unit, determining whether a difference absolute value between a latest average value and a previous average value that is calculated just before the latest average value is within a certain range for a difference value between a maximum average value and a minimum average value, and determines that the average value is stabilized when it is determined that the difference absolute value is within the certain range.

10. The medium according to claim 8, wherein
in the processing to determine whether the average value is stabilized, determining whether a maximum average value and a minimum average value are not equal, determining whether a latest average value is between a first average value that is calculated just before the latest average value and a second average value that is calculated just before the first average value when it is determined that the maximum average value and the minimum average value are not equal, determining whether a difference absolute value between the latest average value and the first average value is within a certain range for a difference value between the maximum average value and the minimum average value when it is determined that the latest average value is between the first average value and the second average value, and determining that the average value is stabilized when it is determined that the difference absolute value is within the certain range.

11. The medium according to claim 8, wherein
in the processing to determine the threshold value, determining the threshold value based on the stabilized average value and threshold value decision information of the threshold value decision rule,
when determination information of the threshold value decision rule indicates that the alert is notified in case in which a numerical value in newly collected business data is less than the threshold value, notifying the alert when the numerical value in the newly collected business data is less than the determined threshold value, or when the determination information indicates that the alert is notified in case in which the numerical value in the newly collected business data exceeds the threshold value, notifying the alert when the numerical value in the newly collected business data exceeds the determined threshold value.

12. The medium according to claim 11, wherein
collecting the business data after the average value is stabilized, calculating an average value of numerical values in the collected business data, and determining whether an evaluation result of the determined threshold value is notified, based on the average value of the numerical values.

13. The medium according to claim 12, wherein
in the processing to notify the evaluation result, determining whether a difference absolute value between a latest average value and the stabilized average value is within a certain range for a difference value between a maximum average value and a minimum average value, and notifying an evaluation result of the determined threshold value when it is determined that the difference absolute value is not within the certain range.

14. The medium according to claim 11, wherein
in the processing to determine the threshold value, calculating an average value of numerical values that correspond to attribute information that is identified by identification information that uniquely identifies attribute information of the numerical value in the threshold value decision rule, and determining the threshold value of the numerical values.

15. A monitoring method that is executed by a monitoring apparatus that monitors a numerical value in business data to be processed by an information processing system that executes business processing, the monitoring method comprising:
collecting a plurality of the numerical values that are a monitoring target based on collection target information of a threshold value decision rule which is predetermined, in response to a setting instruction of the threshold value, by a processor;
calculating an average value of the numerical values for each predetermined time interval, by the processor;
determining whether the average value is stabilized based on variation of a plurality of the average values, by the processor;
storing the threshold value that is determined based on the stabilized average value in a storage unit when it is determined that the average value is stabilized, by the processor; and
determining whether an alert is notified, based on a comparison result of a numerical value in newly collected business data and the determined threshold value, by the processor.
